(19) United States
(12) Patent Application Publication
(10) Pub. No.: US 2010/0149031 A1
(43) Pub. Date: Jun. 17, 2010

(54) SYSTEM AND METHOD FOR DETERMINING FORGED RADIO FREQUENCY MEASUREMENTS

(75) Inventors: Martin DAWSON, Wollongong (AU); Nell HARPER, Mangerton (AU)

Correspondence Address: Duane Morris LLP, 505 9th Street, N.W., Suite 1000, Washington, DC, 20004, US

(73) Assignee: ANDREW LLC, Hickory, NC (US)

(21) Appl. No.: 12/333,820

(22) Filed: Dec. 12, 2008

(51) Int. Cl. G01S 1/00; G01S 3/02

(52) U.S. Cl. 342/357.09; 342/458

(57) ABSTRACT

A system and method for determining whether a wireless device has transmitted one or more forged radio frequency (“RF”) measurements. A first set of signals from a plurality of RF sources may be received at a wireless device and transmitted to a location determining system. The location determining system may receive a second set of signals from the plurality of RF sources during substantially the same time period and frequency range. The location determining system may compare information from the second set of signals with information from the first set of signals. Alternatively, the location determining system may determine a location of the wireless device as a function of the first set of signals and compare information from the second set of signals with the determined location. The wireless device may be identified as having transmitted one or more forged RF measurements if the information from the second set of signals does not substantially correspond to the information from the first set of signals and/or the determined location.

### RELATED APPLICATIONS

The instant application is related to and co-pending with U.S. application Ser. No. 12/325,612, entitled, “System and Method of Protecting Against Spoofed A-GNSS Measurement Data,” filed Dec. 1, 2008, U.S. application Ser. No. 12/276,852, entitled, “System and Method for Determining Falsified Geographic Location of a Mobile Device,” filed Nov. 24, 2008, U.S. application Ser. No. 12/276,917, entitled, “System and Method for Server Side Detection of Falsified Satellite Measurements,” filed Nov. 24, 2008, U.S. application Ser. No. 12/276,804, entitled, “System and Method for Determining Falsified Satellite Measurements,” filed Nov. 24, 2008, and U.S. application Ser. No. 12/272,046, entitled, “System and Method for Determining the Location of a Mobile Device,” filed Nov. 17, 2008, the entirety of each are incorporated herein by reference.

### BACKGROUND

Radio communication systems generally provide two-way voice and data communication between remote locations. Examples of such systems are cellular and personal communication system (“PCS”) radio systems, trunked radio systems, dispatch radio networks, and global mobile personal communication systems (“GMPCS”) such as satellite-based systems. Communication in these systems is conducted according to a pre-defined standard. Mobile devices or stations, also known as handsets, portables or radiotelephones, conform to the system standard to communicate with one or more fixed base stations. It is important to determine the location of such a device capable of radio communication especially in an emergency situation. In addition, in 2001 the United States Federal Communications Commission (“FCC”) required that cellular handsets must be geographically locatable. This capability is desirable for emergency systems such as Enhanced 911 (“E-911”). The FCC requires stringent accuracy and availability performance objectives and demands that cellular handsets be locatable within 100 meters 67% of the time for network based solutions and within 50 meters 67% of the time for handset based solutions.

Current generations of radio communication generally possess limited mobile device location determination capability. In one technique, the position of the mobile device is determined by monitoring mobile device transmissions at several base stations. From time of arrival or comparable measurements, the mobile device's position may be calculated. However, the precision of this technique may be limited and, at times, may be insufficient to meet FCC requirements. In another technique, a mobile device may be equipped with a receiver suitable for use with a Global Navigation Satellite System (“GNSS”) such as the Global Positioning System (“GPS”). GPS is a radio positioning system providing subscribers with highly accurate position, velocity, and time (“PVT”) information.

FIG. 1 is a schematic representation of a constellation 100 of GPS satellites 101. With reference to FIG. 1, GPS may include a constellation of GPS satellites 101 in non-geosynchronous orbits around the earth. The GPS satellites 101 travel in six orbital planes 102 with four of the GPS satellites 101 in each plane. Of course, a multitude of on-orbit spare satellites may also exist. Each orbital plane has an inclination of 55 degrees relative to the equator. In addition, each orbital plane has an altitude of approximately 20,200 km (10,900 miles). The time required to travel the entire orbit is just under 12 hours. Thus, at any given location on the surface of the earth with clear view of the sky, at least five GPS satellites are generally visible at any given time.

With GPS, signals from the satellites arrive at a GPS receiver and are conventionally utilized to determine the position of the receiver. GPS position determination is made based on the time of arrival (“TOA”) of various satellite signals. Each of the orbiting GPS satellites 101 broadcasts spread spectrum microwave signals encoded with satellite ephemeris information and other information that allows a position to be calculated by the receiver. Presently, two types of GPS measurements corresponding to each correlator channel with a locked GPS satellite signal are available for GPS receivers. The two carrier signals, L1 and L2, possess frequencies of 1.5754 GHz and 1.2276 GHz, or wavelengths of 0.1903 m and 0.2442 m, respectively. The L1 frequency carries the navigation data as well as the standard positioning code, while the L2 frequency carries the P code and is used for precision positioning code for military applications. The signals are modulated using bi-phase shift keying techniques. The signals are broadcast at precisely known times and at precisely known intervals and each signal is encoded with its precise transmission time. There is also an L2C signal being transmitted by several satellites. The LC2C signal is a second civilian frequency transmitted by GPS satellites. L1 transmits the Coarse Acquisition (“C/A”) code. L2C transmits L2CM (civil-moderate) and L2CL (civil long) codes. These codes allow a device to differentiate between satellites that are all transmitting on the same frequency. The C/A code is 1 milliseconds long, the L2CM is 20 milliseconds long and the L2CL is 1.5 seconds long. The L2C codes provide a more robust cross-correlation performance so that reception of weak GPS signals is less affected by simultaneously received strong GPS signals. The civil navigation message (“CNAV”) is the broadcast model that can be transmitted on the L2C and provides a more accurate and frequent message than the legacy navigation message.

Conventional GPS receivers measure and analyze signals from the satellites, and estimate the corresponding coordinates of the receiver position, as well as the instantaneous receiver clock bias. Conventional GPS receivers may also measure the velocity of the receiver. The quality of these estimates depends upon the number and the geometry of satellites in view, measurement error and residual biases. Residual biases generally include satellite ephemeris bias, satellite and receiver clock errors, and ionospheric and tropospheric delays. If receiver clocks were perfectly synchronized with the satellite clocks, only three range measurements would be needed to allow a user to compute a three-dimensional position. This process is known as multilateration. However, given the engineering difficulties and the expense of providing a receiver clock whose time is exactly synchronized, conventional systems generally account for the amount by which the receiver clock time differs from the satellite clock time when computing a receiver's position. This clock bias is determined by computing a measurement from a fourth satellite using a processor in the receiver that correlates the ranges measured from each satellite. This process requires four or more satellites from which four or more measurements can be obtained to estimate four unknowns x, y, z, b. The unknowns are latitude, longitude, altitude and receiver clock offset. The amount b, by which the processor has added or subtracted time, is the instantaneous bias between the receiver clock and the satellite clock. It is possible to calculate a location with only three satellites when additional information is available. For example, if the altitude of the handset or mobile device is well known, then an arbitrary satellite measurement may be included that is centered at the center of the earth and possesses a range defined as the distance from the center of the earth to the known altitude of the handset or mobile device. The altitude of the handset may be known from another sensor or from information from the cell location in the case where the handset is in a cellular network.

Satellite coordinates and velocities have been conventionally computed inside the GPS receiver, and the GPS receiver obtains satellite ephemeris and clock correction data by demodulating the satellite broadcast message stream. The satellite transmission contains more than 400 bits of data transmitted at 50 bits per second. The constants contained in the ephemeris data coincide with Kepler orbit constants requiring many mathematical operations to turn the data into position and velocity data for each satellite. In one implementation, this conversion requires 90 multiplies, 58 adds and 21 transcendental function cells (sin, cos, tan) to translate the ephemeris into a satellite position and velocity vector at a single point, for one satellite. Most of the computations also require double precision, floating point processing.

Thus, the computational load for performing the position calculation is significant. Conventional mobile devices generally must therefore include a high-level processor capable of the necessary calculations, and such processors are relatively expensive and consume large amounts of power. Portable devices for consumer use, e.g., a cellular phone or other comparable device, are preferably inexpensive and operate at very low power. These design goals are inconsistent with the high computational load required for GPS processing.

Further, the slow data rate from the GPS satellites is a limitation. GPS acquisition at a GPS receiver may take many seconds or several minutes, during which time the receiver circuit and processor of the mobile device must be continuously energized. Preferably, to maintain battery life in portable receivers and transceivers such as mobile cellular handsets, circuits are de-energized as much as possible. The long GPS acquisition time can rapidly deplete the battery of a mobile device. In any situation and particularly in emergency situations, the long GPS acquisition time is inconvenient.

Assisted-GPS (“A-GPS”) has gained significant popularity recently in light of stringent time to first fix (“TTFF”), i.e., first position determination and sensitivity, requirements of the FCC E-911 regulations. In A-GPS, a communications network and associated infrastructure may be utilized to assist the mobile GPS receiver, either as a standalone device or integrated with a mobile station or device. The general concept of A-GPS is to establish a GPS reference network (and/or a wide-area D-GPS network or a wide area reference network (“WARN”)) including receivers with clear views of the sly that may operate continuously. This reference network may also be connected with the cellular infrastructure, may continuously monitor the real-time constellation status, and may provide data for each satellite at a particular epoch time. For example, the reference network may provide ephemeris information, UTC model information, ionosphere model information, and other broadcast information to the cellular infrastructure. As one skilled in the art would recognize, the GPS reference receiver and its server (or position determining entity) may be located at any surveyed location with an open view of the sky. Typical A-GPS information may include data for determining a GPS receiver's approximate position, time synchronization mark, satellite ephemerides, various model information and satellite dopplers. Different A-GPS services may omit some of these parameters; however, another component of the supplied information is the identification of the satellites for which a device or GPS receiver should search. From such assistance data, a mobile device will attempt to search for and acquire satellite signals for the satellites included in the assistance data. If, however, satellites are included in the assistance data that are not measurable by the mobile device (e.g., the satellite is no longer visible, etc.), then the mobile device will waste time and considerable power attempting to acquire measurements for the satellite.

Therefore, embodiments of the present subject matter may be employed to provide simpler hardware in mobile devices as the circuitry and respective components thereof are needed only for RF capture, downconverting, time stamping and transmission thereof to a respective location determining system. As a result of the simpler architecture, device hardware need not be restricted to GPS or other satellite system frequencies; rather, a server at a respective location determining system may specify the frequency range for RF capture, the amount of time to capture, the sampling rate and the sampling resolution.

Civilian GPS and other RF signals, however, are vulnerable to attacks such as blocking, jamming and spoofing. The goal of such attacks generally is to prevent a position lock (e.g., blocking and jamming) or to feed a receiver false information so that the receiver computes an erroneous time or location (e.g., spoofing). GPS receivers are generally aware when blocking or jamming is occurring because the receivers encounter a loss of signal. Spoofing, however, is a surreptitious attack. Currently, no countermeasures are in use for detecting spoofing attacks.

Civilian GPS signals are widely used by government and private industries for important applications, including, but not limited to, public safety services, navigation, geolocation, hiking, surveying, robotics, tracking, etc. Unfortunately, civilian GPS signals are not secure. Since GPS signal strength, measured at the Earth's surface at about −160 dBw (1×10⁻¹⁶ watts), is roughly equivalent to viewing a 25 watt light bulb from a distance of 10,000 miles, GPS signals may be blocked by destroying or shielding a receiver's antenna and may be jammed by a signal of a similar frequency but greater strength. As stated above, however, blocking and jamming are not the greatest security risk. A more pernicious attack involves feeding the receiver fake or forged satellite signals so that the receiver believes it is located somewhere in space and time that it is not. Spoofing may be accomplished by utilizing a GPS satellite simulator. Such simulators are uncontrolled and widely available. To conduct the spoofing attack, an adversary may broadcast a forged satellite signal with a higher signal strength than the true signal, and the GPS receiver believes that the forged signal is actually a true GPS signal. The receiver may then proceed to calculate erroneous position or time information based on this forged signal.

It is also possible for an unscrupulous user or intermediary to alter the software in a wireless device to manipulate satellite measurements thereby causing a location determining system to calculate an incorrect location. This method of spoofing is generally termed as location spoofing. Generally, if satellite measurements are manipulated in a wireless device randomly, it is likely that a resulting position calculation will fail because the position of the respective satellites will be too far away from the actual code phase indicated location; however, a skillful user may calculate code phases that are required to result in the calculation of a spoofed or false location by the location determining system.

Although embodiments of the present subject matter may not prevent spoofing attacks, these embodiments may alert a wireless device user and/or an operator of a location determining system to such suspicious activity thereby decreasing the probability that a spoofing attack succeeds. Further embodiments of the present subject matter may be implemented easily and inexpensively by retrofitting existing GPS receivers and exemplary location determining systems.

Accordingly, there is a need for a method and system for determining falsified satellite or RF measurements and/or falsified locations of a mobile device that would overcome the deficiencies of the prior art. Therefore, an embodiment of the present subject matter provides a method for determining whether a wireless device has transmitted one or more forged RF measurements. The method may comprise receiving at a wireless device a first set of signals from a plurality of RF sources and transmitting the first set of signals from the wireless device to a location determining system. The location determining system may receive a second set of signals from the plural RF sources and then compare information from the second set of signals with information from the first set of signals. The wireless device may be identified as having transmitted one or more forged RF measurements if the information from the second set of signals does not substantially correspond to the information from the first set of signals.

In a further embodiment of the present subject matter, a system is provided for determining whether a wireless device has transmitted one or more forged measurements from signals received from a plurality of RF sources. The system may include a wireless device having a receiver for receiving a first set of signals from the plurality of RF sources and a transmitter for transmitting the received first set of signals. The system may further include a location determining system having a receiver for receiving the first set of signals transmitted from the wireless device and for receiving a second set of signals from the plural RF sources, circuitry for comparing information from the second set of signals with information from the first set of signals, and circuitry for identifying the wireless device as having transmitted one or more forged RF measurements if the information from the second set of signals does not substantially correspond to the information from the first set of signals.

In an additional embodiment of the present subject matter, a method is provided for determining whether an estimated location of a wireless device includes one or more forged RF measurements. The method may comprise receiving at a wireless device a first set of signals from a plurality of RF sources and transmitting the first set of signals from the wireless device to a location determining system. An estimated location of the wireless device may be determined at the location determining system as a function of the transmitted first set of signals. A second set of signals may be received from the plural RF sources as a function of the estimated location. Information from the second set of signals may be compared with information provided by a database, and the estimated location identified as including one or more forged RF measurements if the information from the second set of signals does not substantially correspond to the information provided from the database.

In another embodiment of the present subject matter, a method is provided for determining whether a wireless device has transmitted one or more forged RF measurements. The method may comprise receiving at a wireless device a first set of signals from a plurality of RF sources and transmitting the first set of signals from the wireless device to a location determining system. An estimated location of the wireless device may be determined at the location determining system as a function of the transmitted first set of signals. The location determining system may receive a second set of signals from the plural RF sources and compare information from the second set of signals with the estimated location. The wireless device may then be identified as having transmitted one or more forged RF measurements if the information from the second set of signals does not substantially correlate with the estimated location.

A further embodiment of the present subject matter provides a method for determining whether a wireless device has transmitted one or more forged RF measurements. The method may comprise receiving at a location determining system a first set and a second set of signals from a plurality of RF sources during substantially the same time period, the first set of signals being transmitted from a wireless device. Information from the second set of signals may be compared with information from the first set of signals, and the wireless device may be identified as having transmitted one or more forged RF measurements if the information from the second set of signals does not substantially correspond to the information from the first set of signals.

One embodiment of the present subject matter provides a method for determining the veracity of a location of a wireless device. The method may comprise determining an estimated location of the wireless device at a location determining system as a function of signals transmitted from the wireless device. The estimated location of the device may be compared with information from a second set of signals received during substantially the same period as the signals received from the wireless device, and the estimated location identified as including one or more forged radio frequency measurements if the information from the second set of signals does not substantially correspond to estimated location.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

FIG. 1 is a schematic representation of a constellation of GPS satellites.

FIG. 2 is an illustration of one embodiment of the present subject matter.

FIG. 3 is an illustration of another embodiment of the present subject matter.

FIG. 4 is an algorithm according to one embodiment of the present subject matter.

FIG. 5 is an algorithm according to another embodiment of the present subject matter.

FIG. 6 is an algorithm according to an embodiment of the present subject matter.

FIG. 7 is a schematic representation for implementing one embodiment of the present subject matter.

### DETAILED DESCRIPTION

With reference to the figures where like elements have been given like numerical designations to facilitate an understanding of the present subject matter, the various embodiments of a system and method for determining forged radio frequency measurements are herein described.

The disclosure relates to methods and apparatuses for determining geolocation of a mobile appliance using satellite signals. The satellites may be considered as part of a Global Navigation Satellite System (“GNSS”), such as, but not limited to, the U.S. Global Positioning System (“GPS”). While the following description references the GPS system, this in no way should be interpreted as limiting the scope of the claims appended herewith. As is known to those of skill in the art, other GNSS systems operate, for the purposes of this disclosure, similarly to the GPS system, such as, but not limited to, the European Satellite project, Galileo; the Russian satellite navigation system, GLONASS; the Japanese Quasi-Zenith Satellite System (“QZSS”), and the Chinese satellite navigation and positioning system called Beidou (or Compass). Therefore, references in the disclosure to GPS and/or GNSS, where applicable, as known to those of skill in the art, apply to the above-listed GNSS systems as well as other GNSS systems not listed above. Further, embodiments of the present subject matter may also receive radio frequency (“RF”) signals from a cellular network, a Satellite Based Augmentation Systems (“SBAS”), a Wide Area Augmentation System (“WAAS”), the European Geostationary Navigation Overlay Service (“EGNOS”), a digital television network, and other terrestrial or airborne RF sources. Further, the terms spoofed, falsified, forged, and various tenses and forms thereof are utilized interchangeably throughout this disclosure and such use should in no way should be interpreted as limiting the scope of the claims appended herewith.

Generally wireless A-GPS devices or handsets have a low time to first fix (“TTFF”) as the devices are supplied with assistance data from an exemplary communications network to assist in locking onto or acquiring satellites quickly. Exemplary network elements that supply the assistance data may be a location determining system such as a Mobile Location Center (“MLC”), location information server or system (“LIS”), or other comparable network element. The location determining system may generally be a node in a wireless network that performs the location of a mobile device.

In one embodiment of the present subject matter, a mobile device may receive signals from any RF source, downconvert these RF signals to an intermediate frequency (“IF”) signal, time stamp the downconverted signal and provide the time stamped signal to a location determining system. The location determining system may then process the received data and calculate a location for the mobile device. This process may result in a simplification of hardware in the mobile device, may reduce battery consumption, and may allow a mobile device to capture any number of RF signals from various RF sources. Therefore, mobile devices may become an extensible device utilized by a network to capture signals from several RF sources as new signals become available for positioning or other purposes. In such embodiments, a server at an MLC or LIS may be updated to utilize these new signals.

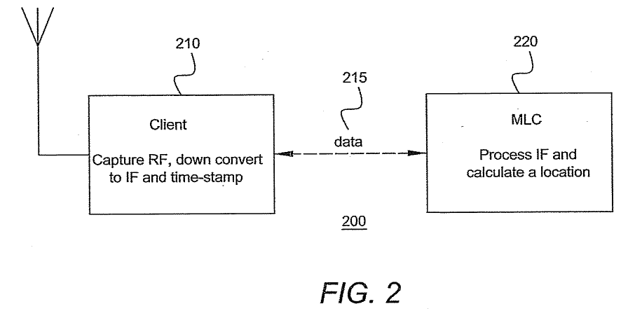

FIG. 2 is an illustration of one embodiment of the present subject matter. With reference to FIG. 2, a mobile device or client 210 may be in a wire-line or a wireless network 200 and may initiate a location calculation. Of course, the location calculation may be initiated by a location determining system such as an MLC 220. The MLC 220 may also specify a predetermined frequency range of RF data to collect, a predetermined sampling duration to receive a set of RF signals, a predetermined sampling rate for each sample, a predetermined sampling resolution (e.g., number of bits per sample), a time synchronization, and combinations thereof. For example, the MLC 220 may specify that the client 210 collect RF data in the L1 frequency range for GPS signals for 50 milliseconds at a sampling rate of 5.714 MHz, a sampling resolution of 2 bits per sample, and the MLC 220 may also provide current GPS time to the client 210. The client 210 may then receive and/or record RF signals in the specified GPS frequency range at the specified sampling rate and resolution for the 50 milliseconds and time stamp the respective data 215. In one embodiment, the client 210 may target a specific frequency range utilizing conventional filtering techniques. The time stamped data 215 may then be provided through the network 200 to the MLC 220. In one embodiment, the MLC 220 may perform GPS satellite acquisition and position calculation functions to determine an estimated location of the client 210.

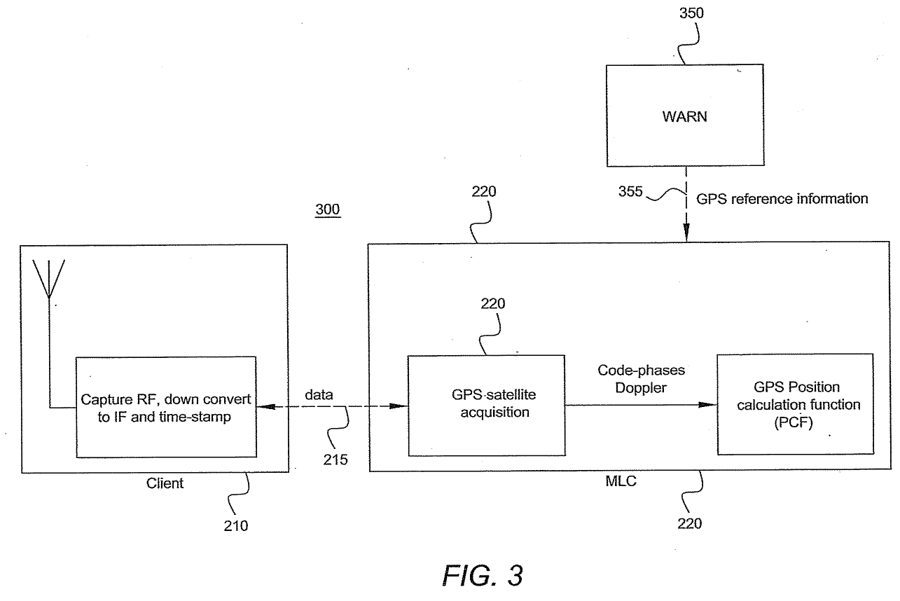

FIG. 3 is an illustration of another embodiment of the present subject matter. With reference to FIG. 3, an MLC 220 may be provided with or utilize GPS reference information 355 from a wide area reference network (“WARN”) 350 or other comparable reference network to determine an estimated location of the client 210. Exemplary GPS reference information may be, but is not limited to, ephemeris information, ionosphere model information, UTC model information, and other information commonly provided by a reference network.

In another embodiment of the present subject matter, the MLC 220 may request the client 210 to measure RF signals in a frequency range compatible with another GNSS or even in a frequency range compatible with a terrestrial transmitter. In this embodiment, the MLC 220, upon receiving downconverted data 215 from the client 210, may acquire appropriate signals in a manner compatible with the signals that were requested and perform a position calculation that is specific to that signal type. The MLC 220 may also request from the client RF signals more than once and may request the RF signals for different lengths of time and for different frequency ranges, sampling rates, and sampling resolutions. For example, for a location estimate of a client based upon GPS signals, an exemplary MLC 220 may request one millisecond of data to be captured in an appropriate GPS frequency range. In the event the MLC 220 cannot acquire sufficient satellites within the specified sample duration, then the client 210 may be in area having significant attenuation, etc. In this instance, the MLC 220 may request that the client 210 collect 50 milliseconds of data and/or may specify a different frequency range so that the client 210 utilizes a different GNSS or utilizes terrestrial transmitters. Of course, the location transaction may be server initiated or client initiated as described in co-pending and related U.S. application Ser. No. 12/272,046, entitled, “System and Method for Determining the Location of a Mobile Device,” filed Nov. 17, 2008, the entirety of which is incorporated herein by reference.

In another embodiment of the present subject matter, the MLC may measure additional available signals from various RF sources that provide additional information about the location of a wireless device. Generally, these additional available signals are measured during substantially the same time slice or period that the MLC receives measurements from the wireless device; however, it is envisioned that embodiments of the present subject matter may be provided with additional signals from a various wireless and/or wireline sources and such an example should not limit the scope of the claims appended herewith. The MLC may then compare this additional information to the signals utilized to calculate or determine the location of the device. For example, if an A-GPS location for a device is being determined, then a respective MLC may attempt to extract cellular signals or signals from other terrestrial RF sources such as digital television transmitters, cellular transmitters, etc., during substantially the same time duration that the MLC is receiving the signals from the wireless device. These additional signals may provide information about the wireless device that can be utilized to confirm or refute the location estimated from the signals provided by the wireless device. By way of another non-limiting example, if the additional information extracted by the MLC identifies a serving cell for a cell not in the vicinity of the calculated location, then the calculated location may be suspect and refuted. Similarly, if a signal is measured from another terrestrial RF transmitter that is not in the vicinity of the calculated location, then the calculated location may also be suspect and refuted.

In an alternative embodiment of the present subject matter, an exemplary MLC or LIS may search for signals from RF sources which the MLC or LIS knows should be visible from a calculated or indicated location. As is known in the art, cellular network signals, digital television signals, and other relatively constant RF signals may thus be utilized to form a signature corresponding to specific areas in a communications network. The MLC or LIS may maintain or access a database of these signatures and compare measurements received from a wireless device for consistency with the signature(s).

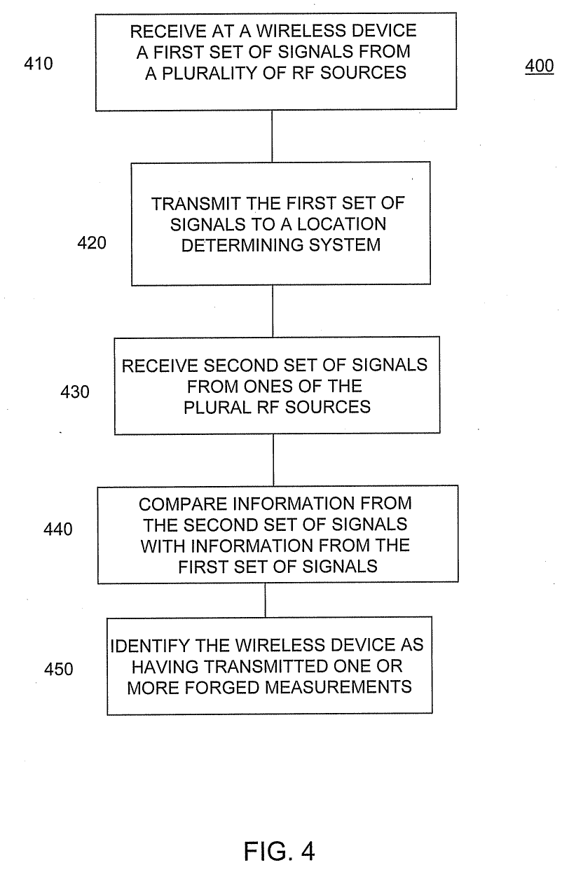

FIG. 4 is an algorithm according to one embodiment of the present subject matter. With reference to FIG. 4, a method 400 for determining whether a wireless device has transmitted one or more forged RF measurements is provided. At step 410, a first set of signals from a plurality of RF sources may be received at a wireless device. The first set of signals may be downconverted to an intermediate frequency range and time stamped at the wireless device. In one embodiment, the location determining system may transmit to the wireless device at least one of a location request, a predetermined frequency range, a predetermined sampling period to receive the first set of signals, a time synchronization, a sampling interval, a sampling duration, and combinations thereof. The wireless device may transmit, at step 420, the first set of signals to a location determining system, e.g., an MLC or LIS. At step 430, the location determining system may receive a second set of signals from the plural RF sources. In one embodiment, the RF source for the first set of signals may be mutually exclusive of the RF source for the second set of signals. Exemplary RF sources may be, but are not limited to, a cellular network, a GNSS, a GPS, Galileo system, GLONASS system, QZSS, Compass system, Bediou system, SBAS, WAAS, EGNOS, digital television network, and combinations thereof. The first and second sets of signals may or may not be received at the location determining system during substantially the same period and in substantially the same frequency range. Information from the second set of signals may be compared with information from the first set of signals at step 440. The wireless device may then be identified as having transmitted one or more forged RF measurements if the information from the second set of signals does not substantially correspond to the information from the first set of signals at step 450. In one embodiment, the method 400 may further include determining an estimated location of the wireless device at the location determining system as a function of the transmitted first set of signals.

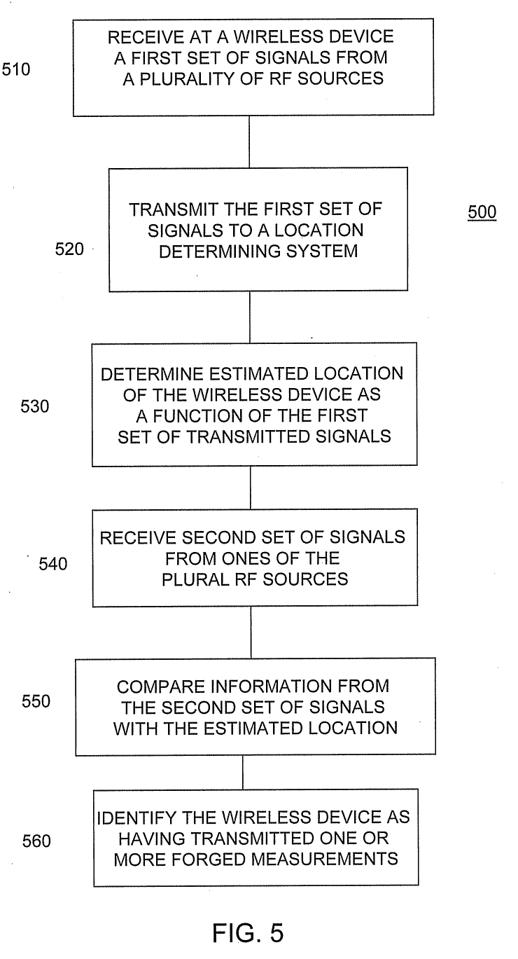

FIG. 5 is an algorithm according to another embodiment of the present subject matter. With reference to FIG. 5, a method 500 for determining whether a wireless device has transmitted one or more forged RF measurements is provided. At step 510, a first set of signals may be received at a wireless device from a plurality of RF sources. The first set of signals may be downconverted to an intermediate frequency range and time stamped at the wireless device. In another embodiment, the location determining system may transmit to the wireless device at least one of a location request, a predetermined frequency range, a predetermined sampling period to receive the first set of signals, a time synchronization, a sampling interval, a sampling duration, and combinations thereof. The wireless device may transmit the first set of signals to a location determining system at step 520. An estimated location of the wireless device may then be determined at the location determining system as a function of the transmitted first set of signals at step 530. The location determining system may receive a second set of signals from the plural RF sources at step 540 and, at step 550, compare information from the second set of signals with the estimated location. The first and second sets of signals may or may not be received at the location determining system during substantially the same period and/or frequency range. In one embodiment, the RF source for the first set of signals may be mutually exclusive of the RF source for the second set of signals. The wireless device may then be identified as having transmitted one or more forged RF measurements if the information from the second set of signals does not substantially correlate with the estimated location at step 560.

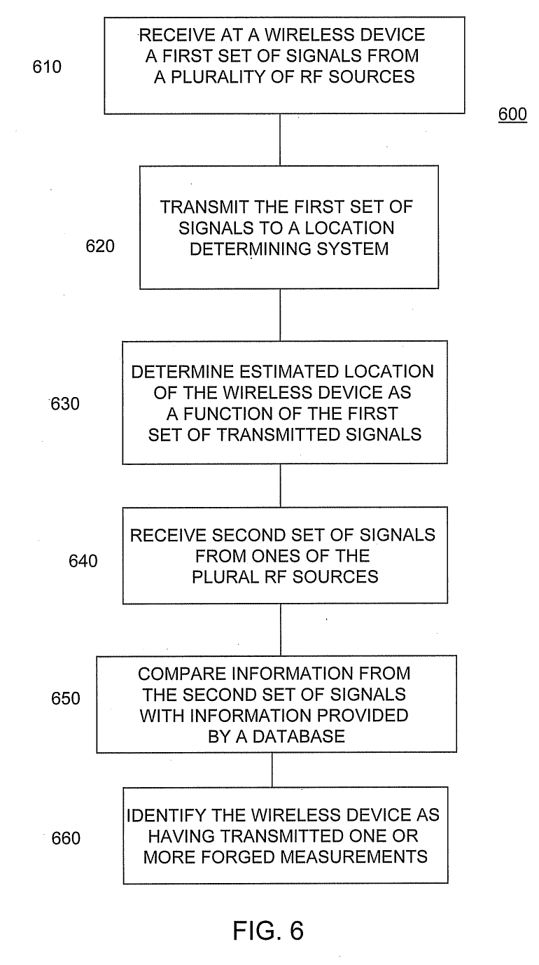

FIG. 6 is an algorithm according to an embodiment of the present subject matter. With reference to FIG. 6, a method 600 for determining whether an estimated location of a wireless device includes one or more forged RF measurements is provided. At step 610, a wireless device may receive a first set of signals from a plurality of RF sources, and at step 620 transmit the first set of signals to a location determining system. In another embodiment, the location determining system may transmit to the wireless device at least one of a location request, a predetermined frequency range, a predetermined sampling period to receive the first set of signals, a time synchronization, a sampling interval, a sampling duration, and combinations thereof. The first set of signals may be downconverted to an intermediate frequency range and time stamped at the wireless device. At step 630, an estimated location of the wireless device may be determined at the location determining system as a function of the transmitted first set of signals. The location determining system may receive, at step 640, a second set of signals from the plural RF sources as a function of the estimated location. The first and second sets of signals may or may not be received at the location determining system during substantially the same period and/or frequency range. Information from the second set of signals may then be compared with information provided by a database at step 650. In one embodiment, the RF source for the first set of signals may be mutually exclusive of the RF source for the second set of signals. The estimated location may be identified as including one or more forged RF measurements if the information from the second set of signals does not substantially correspond to the information provided from the database at step 660. In one embodiment, the information provided from the database may be a signature of expected RF signals at the estimated location. Another embodiment may include transmitting from the location determining system to the wireless device at least one of a location request, a predetermined frequency range, a predetermined sampling period to receive the first set of signals, a time synchronization, a sampling interval, a sampling duration, and combinations thereof.

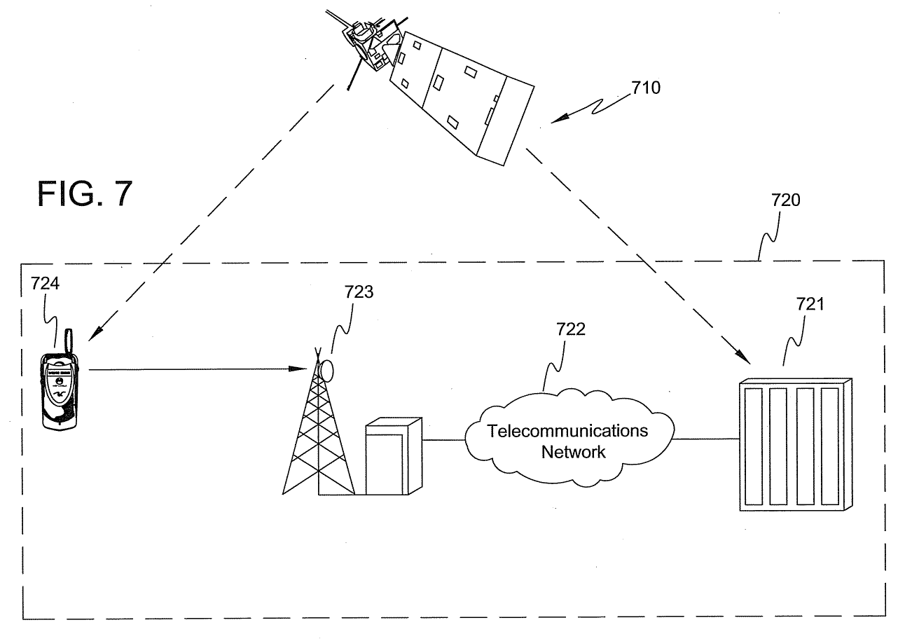

FIG. 7 is a schematic representation for implementing one embodiment of the present subject matter. With reference to FIG. 7, a satellite system 710 may communicate with a terrestrial system 720. An exemplary satellite system 710 may be a GNSS such as, but not limited to, a GPS, Galileo system, GLONASS system, QZSS, Compass system, Bediou system, etc. The ground system 720 may include a cellular network having a location center 721 and may receive information from or include a SBAS, WAAS, EGNOS, digital television network, and combinations thereof. The location center 721 may be an MLC, LIS or other network component such as a central office configured to communicate with a telecommunications network 722 and/or at least one base station 723. The location center 721 may include a receiver for receiving signals transmitted from a mobile device 724, and circuitry for determining the location of the mobile device 724 as a function of received signals from the device 724, circuitry for comparing information from the signals received from the device 724 with information received from other RF sources or a database, and circuitry for identifying the device 724 as having transmitted one or more forged RF measurements if the information from the device's transmitted signals does not substantially correspond to the information received from other RF sources and/or a determined location of the mobile device 724.

The location center 721 may include a database having signatures of RF sources that correspond to specific areas in a communications network. The location center 721 may also include a database having information from a reference network such as a WARN. In a further embodiment, the location center 721 may include a transmitter for transmitting to the mobile device 724 at least one of a location request, a predetermined frequency range, a predetermined sampling duration, a predetermined sampling rate, a predetermined sampling resolution to receive signals from plural RF sources, and a time synchronization. An exemplary device 724 may include a receiver for receiving signals from the plural RF sources, circuitry for downconverting the received signals, circuitry for time stamping the downconverted signals, and/or a transmitter for transmitting the time stamped signals. Exemplary devices 724 may be, but are not limited to, a cellular device, text messaging device, computer, portable computer, vehicle locating device, vehicle security device, communication device, or wireless transceiver.

The location center 721 may or may not receive a preliminary estimate of the device's location or boundary thereof on the basis of the device's serving or neighboring cell site, sector, network boundary, or other area. The location center 721 may also determine a plurality of satellites as a function of this boundary or region and determine whether any one or more of these plural satellites, while operational, are not visible by the device 724 for some reason. The location center 721 may also receive satellite information from GPS satellites or any other RF source. The satellite information may include the satellite's broadcast ephemeris information of the broadcasting satellite, that of all satellites, or that of selected satellites. Further, the location center 721 may manipulate any assistance data to prevent the device 724 from searching and attempting to acquire RF signals from one or more satellites or RF signals from other RF sources. This information may then be transmitted or relayed to the device 724 and utilized for location determination by the center 721. The location center 721 may relay the information back to the device 724 or use the information, either singularly or along with some preliminary estimation of the device's location, to assist in determining a geographic location of the device 724.

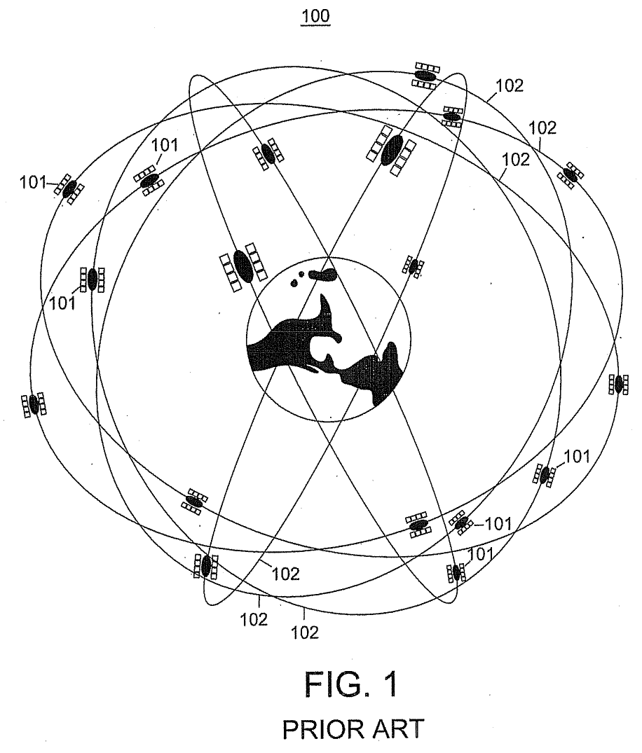

As shown by the various configurations and embodiments illustrated in FIGS. 1-7, a method and system for determining forged radio frequency measurements have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What we claim is:

1. A method for determining whether a wireless device has transmitted one or more forged radio frequency (“RF”) measurements, comprising the steps of:
(a) receiving at a wireless device a first set of signals from a plurality of RF sources;
(b) transmitting the first set of signals from the wireless device to a location determining system;
(c) determining an estimated location of the wireless device at the location determining system as a function of the transmitted first set of signals;
(d) receiving at the location determining system a second set of signals from the plurality of RF sources;
(e) comparing information from the second set of signals with the estimated location; and
(f) identifying the wireless device as having transmitted one or more forged RF measurements if the information from the second set of signals does not substantially correlate with the estimated location.

2. The method of claim 1 wherein the first and second sets of signals are received at the location determining system during substantially the same period.

3. The method of claim 1 wherein the first and second sets of signals are received in substantially the same frequency band.

4. The method of claim 1 wherein the RF source for the first set of signals is mutually exclusive of the RF source for the second set of signals.

5. The method of claim 1 further comprising the step of downconverting and time stamping the first set of signals at the wireless device.

6. The method of claim 1 wherein the transmitted first set of signals is in an intermediate frequency range.

7. The method of claim 1 wherein the location determining system is a mobile location center (“MLC”) or a location information server (“LIS”).

8. The method of claim 1 wherein the plural RF sources are selected from the group consisting of: a cellular network, a Global Navigation Satellite System (“GNSS”), a Global Positioning System (“GPS”), Galileo system, GLONASS system, Quasi-Zenith Satellite System (“QZSS”), Compass system, Bediou system, Satellite Based Augmentation Systems (“SBAS”), Wide Area Augmentation System (“WAAS”), European Geostationary Navigation Overlay Service (“EGNOS”), digital television network, and combinations thereof.

9. The method of claim 1 wherein the wireless device is selected from the group consisting of: cellular device, text messaging device, computer, portable computer, vehicle locating device, vehicle security device, communication device, and wireless transceiver.

10. The method of claim 1 wherein the location of the device is determined as a function of information from a wide area reference network (“WARN”).

11. A method for determining whether a wireless device has transmitted one or more forged radio frequency (“RF”) measurements, comprising the steps of:
(a) receiving at a wireless device a first set of signals from a plurality of RF sources;
(b) transmitting the first set of signals from the wireless device to a location determining system;
(c) receiving at the location determining system a second set of signals from the plurality of RF sources;
(d) comparing information from the second set of signals with information from the first set of signals; and
(e) identifying the wireless device as having transmitted one or more forged RF measurements if the information from the second set of signals does not substantially correspond to the information from the first set of signals.

12. The method of claim 11 wherein the first and second sets of signals are received at the location determining system during substantially the same period.

13. The method of claim 11 wherein the first and second sets of signals are received in substantially the same frequency band.

14. The method of claim 11 wherein the RF source for the first set of signals is mutually exclusive of the RF source for the second set of signals.

15. The method of claim 11 further comprising the step of determining an estimated location of the wireless device at the location determining system as a function of the transmitted first set of signals.

16. The method of claim 11 further comprising the step of downconverting and time stamping the first set of signals at the wireless device.

17. The method of claim 11 wherein the transmitted first set of signals is in an intermediate frequency range.

18. The method of claim 11 wherein the location determining system is a mobile location center (“MLC”) or a location information server (“LIS”).

19. The method of claim 11 further comprising the step of transmitting from the location determining system to the wireless device at least one of a location request, a predetermined frequency range, a predetermined sampling period to receive the first set of signals, a time synchronization, a sampling interval, a sampling duration, and combinations thereof.

20. The method of claim 11 wherein the plural RF sources are selected from the group consisting of: a cellular network, a Global Navigation Satellite System (“GNSS”), a Global Positioning System (“GPS”), Galileo system, GLONASS system, Quasi-Zenith Satellite System (“QZSS”), Compass system, Bediou system, Satellite Based Augmentation Systems (“SBAS”), Wide Area Augmentation System (“WAAS”), European Geostationary Navigation Overlay Service (“EGNOS”), digital television network, and combinations thereof.

21. The method of claim 11 wherein the wireless device is selected from the group consisting of: cellular device, text messaging device, computer, portable computer, vehicle locating device, vehicle security device, communication device, and wireless transceiver.

22. A method for determining whether an estimated location of a wireless device includes one or more forged radio frequency (“RF”) measurements, comprising the steps of:
(a) receiving at a wireless device a first set of signals from a plurality of RF sources;
(b) transmitting the first set of signals from the wireless device to a location determining system;
(c) determining an estimated location of the wireless device at the location determining system as a function of the transmitted first set of signals;
(d) receiving a second set of signals at the location determining system from the plurality of RF sources as a function of the estimated location;
(e) comparing information from the second set of signals with information provided by a database; and
(f) identifying the estimated location as including one or more forged RF measurements if the information from the second set of signals does not substantially correspond to the information provided by the database.

23. The method of claim 22 wherein the first and second sets of signals are received at the location determining system during substantially the same period.

24. The method of claim 22 wherein the first and second sets of signals are received in substantially the same frequency band.

25. The method of claim 22 wherein the RF source for the first set of signals is mutually exclusive of the RF source for the second set of signals.

26. The method of claim 22 further comprising the step of downconverting and time stamping the first set of signals at the wireless device.

27. The method of claim 22 wherein the information provided from the database is a signature of expected RF signals at the estimated location.

28. The method of claim 22 wherein the transmitted first set of signals is in an intermediate frequency range.

29. The method of claim 22 wherein the location determining system is a mobile location center (“MLC”) or a location information server (“LIS”).

30. The method of claim 22 further comprising the step of transmitting from the location determining system to the wireless device at least one of a location request, a predetermined frequency range, a predetermined sampling period to receive the first set of signals, a time synchronization, a sampling interval, a sampling duration, and combinations thereof.

31. The method of claim 22 wherein the plural RF sources are selected from the group consisting of: a cellular network, a Global Navigation Satellite System (“GNSS”), a Global Positioning System (“GPS”), Galileo system, GLONASS system, Quasi-Zenith Satellite System (“QZSS”), Compass system, Bediou system, Satellite Based Augmentation Systems (“SBAS”), Wide Area Augmentation System (“WAAS”), European Geostationary Navigation Overlay Service (“EGNOS”), digital television network, and combinations thereof.

32. The method of claim 22 wherein the wireless device is selected from the group consisting of: cellular device, text messaging device, computer, portable computer, vehicle locating device, vehicle security device, communication device, and wireless transceiver.

33. A system for determining whether a wireless device has transmitted one or more forged measurements from signals received from a plurality of radio frequency (“RF”) sources comprising:
(a) a wireless device having:
(i) a receiver for receiving a first set of signals from a plurality of RF sources, and
(ii) a transmitter for transmitting the received first set of signals; and
(b) a location determining system having:
(i) a receiver for receiving the first set of signals transmitted from the wireless device and for receiving a second set of signals transmitted from the plurality of RF sources,
(ii) circuitry for comparing information from the second set of signals with information from the first set of signals, and
(iii) circuitry for identifying the wireless device as having transmitted one or more forged RF measurements if the information from the second set of signals does not substantially correspond to the information from the first set of signals.

34. The system of 33 wherein the location determining system further comprises:
(iv) circuitry for determining the location of the wireless device as a function of the received signals from the device; and
(v) circuitry for comparing information from the second set of signals with the determined location of the wireless device.

35. The system of claim 33 wherein the first and second sets of signals are received by the location determining system during substantially the same period and frequency range.

36. The system of claim 33 wherein the wireless device further comprises:
(iii) circuitry for downconverting the received signals, and
(iv) circuitry for time stamping the downconverted signals.

37. The system of claim 33 wherein the location determining system further includes a database having information from a wide area reference network (“WARN”).

38. The system of claim 33 wherein the location determining system further includes a database having signatures of RF sources that correspond to specific areas.

39. The system of claim 33 wherein the plural RF sources are selected from the group consisting of: a cellular network, a Global Navigation Satellite System (“GNSS”), a Global Positioning System (“GPS”), Galileo system, GLONASS system, Quasi-Zenith Satellite System (“QZSS”), Compass system, Bediou system, Satellite Based Augmentation Systems (“SBAS”), Wide Area Augmentation System (“WAAS”), European Geostationary Navigation Overlay Service (“EGNOS”), digital television network, and combinations thereof.

40. The system of claim 33 wherein the wireless device is selected from the group consisting of: cellular device, text messaging device, computer, portable computer, vehicle locating device, vehicle security device, communication device, and wireless transceiver.

41. The system of claim 33 wherein the location determining system further includes a transmitter for transmitting to the wireless device at least one of a location request, a predetermined frequency range, a predetermined sampling period to receive signals from the plural RF sources, and a time synchronization.

42. A method for determining whether a wireless device has transmitted one or more forged radio frequency (“RF”) measurements, comprising the steps of:
(a) receiving at a location determining system a first set and a second set of signals from a plurality of RF sources during substantially the same time period, the first set of signals being transmitted from a wireless device;
(b) comparing information from the second set of signals with information from the first set of signals; and
(c) identifying the wireless device as having transmitted one or more forged RF measurements if the information from the second set of signals does not substantially correspond to the information from the first set of signals.

43. A method for determining the veracity of a location of a wireless device, comprising the steps of:
(a) determining an estimated location of the wireless device at a location determining system as a function of signals transmitted from the wireless device;
(b) comparing the estimated location with information from a second set of signals received during substantially the same period as the signals received from the wireless device; and
(c) identifying the estimated location as including one or more forged radio frequency measurements if the information from the second set of signals does not substantially correspond to estimated location.

44. The method of claim 43 wherein the signals transmitted from the wireless device are in an intermediate frequency range.

45. The method of claim 43 wherein the signals transmitted from the wireless device are one or more satellite measurements.

46. The method of claim 43 wherein the second set of signals are received from plural RF sources selected from the group consisting of: a cellular network, a Global Navigation Satellite System (“GNSS”), a Global Positioning System (“GPS”), Galileo system, GLONASS system, Quasi-Zenith Satellite System (“QZSS”), Compass system, Bediou system, Satellite Based Augmentation Systems (“SBAS”), Wide Area Augmentation System (“WAAS”), European Geostationary Navigation Overlay Service (“EGNOS”), digital television network, and combinations thereof.
